(19) United States
(12) Patent Application Publication
(10) Pub. No.: US 2018/0335671 A1
(43) Pub. Date: Nov. 22, 2018

(54) LIQUID CRYSTAL PANEL AND DISPLAY DEVICE

(71) Applicant: Shenzhen China Star Optoelectronics Technology Co., Ltd., Shenzhen, Guangdong (CN)

(72) Inventor: Chih Ming Yang, Shenzhen, Guangdong (CN)

(73) Assignee: Shenzhen China Star Optoelectronics Technology Co., Ltd., Shenzhen, Guangdong (CN)

(21) Appl. No.: 15/326,585

(22) PCT Filed: Dec. 28, 2016
(86) PCT No.: PCT/CN2016/112661

§ 371 Date: Nov. 1, 2017

(30) Foreign Application Priority Data
Nov. 2, 2016 (CN) 201610945489.9

(51) Int. Cl. G02F 1/1343; G02F 1/1362

(52) U.S. Cl. CPC G02F 1/134309; G02F 2201/123; G02F 2001/134345; G02F 1/136286

(57) ABSTRACT

Disclosed are a liquid crystal panel and a display device, which belong to the technical field of display, and solve the technical problem that color washout exists in VA display devices. The liquid crystal panel includes a plurality of sub-pixel units arranged in an array, and each of the sub-pixel units includes at least two sub-pixels. At least one sub-pixel in one sub-pixel unit has a potential the same as that of at least one sub-pixel in an adjacent sub-pixel unit.

### CROSS-REFERENCE TO RELATED APPLICATIONS

The present application claims the priority of Chinese patent application CN 201610945489.9, entitled “Liquid Crystal Panel and Display Device” and filed on Nov. 2, 2016, the entirety of which is incorporated herein by reference.

### FIELD OF THE INVENTION

The present disclosure relates to the technical field of display, and in particular, to a liquid crystal panel and a display device.

### BACKGROUND OF THE INVENTION

With the development of display technology, liquid crystal display screens have been the most common display devices. Since liquid crystal display screens have superior characteristics such as high space utilization rate, low power consumption, no radiation and low electromagnetic interference, they have been widely used in information communication tools such as televisions, cellphones and tablet computers.

Vertical alignment (VA) display devices are common liquid crystal display devices, in which liquid crystal molecules are perpendicular to the upper and lower substrates, and the upper and lower polarizers are mutually perpendicular to form a normally black mode. Due to birefringent characteristics of liquid crystal molecules, when a display screen is observed with a vertical polarizer, it is discovered that a display screen has different brightness changes at different observation angles, i.e., along with the change of the inclination angle of liquid crystal molecules. In other words, this leads to the phenomenon of color washout, and simultaneously, results in the drawback that viewing angle of VA display device is narrow.

Currently, the usual practice is to enable liquid crystal molecules to have different inclination angles. As shown in FIG. 1, liquid crystal molecules 30 filled between an upper substrate 10 and a lower substrate 20 are divided into two domains, and the liquid crystal molecules 30 in each domain have different inclination angles. In this manner, when the display screen is observed at different angles, the observed brightness tends to be more identical, such that the viewing angle of VA display device can be enlarged. Further, liquid crystal molecules can also be divided into more domains with different inclination angles. For example, they can be divided into four domains or eight domains.

However, in the multi-domain technical solution, the problem of color washout still exists to a certain extent when the screen is observed at a large viewing angle. As a result, the viewing angle of VA display device is relatively small.

### SUMMARY OF THE INVENTION

The present disclosure aims to provide a liquid crystal panel and a display device so as to solve the technical problem of color washout in the existing VA display device.

The present disclosure provides a liquid crystal panel, which comprises a plurality of sub-pixel units arranged in an array. Each of the sub-pixel units comprises at least two sub-pixels. At least one sub-pixel in one sub-pixel unit has a potential the same as that of at least one sub-pixel in an adjacent sub-pixel unit.

Further, each of the sub-pixels is provided with a pixel electrode. The pixel electrode of at least one sub-pixel in one sub-pixel unit is connected with the pixel electrode of at least one sub-pixel in an adjacent sub-pixel unit.

Preferably, the pixel electrodes are connected to each other by a metal line.

Preferably, the metal line is arranged in a same layer as data lines.

Further, each sub-pixel is divided into at least four domains, and liquid crystal molecules in each of the domains have their own inclination angles.

In a first implementation, each sub-pixel unit comprises one primary sub-pixel and one secondary sub-pixel. The primary sub-pixel in one sub-pixel unit has a potential the same as that of the secondary sub-pixel in an adjacent sub-pixel unit.

In a second implementation, each sub-pixel unit comprises a first sub-pixel, a second sub-pixel and a third sub-pixel. In three adjacent sub-pixel units, the second sub-pixel in a middle sub-pixel unit has a potential the same as that of the first sub-pixel in a left sub-pixel unit, and the same as that of the third sub-pixel in a right sub-pixel unit.

In a third implementation, each sub-pixel unit comprises a first sub-pixel, a second sub-pixel and a third sub-pixel. The second sub-pixel in one sub-pixel unit has a potential the same as that of the first sub-pixel and the third sub-pixel in an adjacent sub-pixel unit.

The present disclosure further provides a display device. The display device comprises a liquid crystal panel, which comprises a plurality of sub-pixel units arranged in an array. Each of the sub-pixel units comprises at least two sub-pixels. At least one sub-pixel in one sub-pixel unit has a potential the same as that of at least one sub-pixel in an adjacent sub-pixel unit.

Further, each of the sub-pixels of the liquid crystal panel is provided with a pixel electrode. The pixel electrode of at least one sub-pixel in one sub-pixel unit is connected with the pixel electrode of at least one sub-pixel in an adjacent sub-pixel unit.

Preferably, the pixel electrodes of the liquid crystal panel are connected to each other by a metal line.

Preferably, the metal line of the liquid crystal panel is arranged in a same layer as data lines.

Further, each sub-pixel of the liquid crystal panel is divided into at least four domains, and liquid crystal molecules in each of the domains have their own inclination angles.

Preferably, the display device is a vertical alignment liquid crystal display device.

The present disclosure has the following beneficial effects. The liquid crystal panel provided by the present disclosure comprises a plurality of sub-pixel units arranged in an array, and each of the sub-pixel units comprises at least two sub-pixels. At least one sub-pixel in one sub-pixel unit has a potential the same as that of at least one sub-pixel in an adjacent sub-pixel unit. In such case, a plurality of sub-pixels in one sub-pixel unit can have different potentials. Therefore, liquid crystal molecules in different sub-pixels will also have different inclination angles, which reduces color washout phenomenon at a large viewing angle, thus enlarging the viewing angle of the display device.

Other features and advantages of the present disclosure will be further explained in the following description, and partly become self-evident therefrom, or be understood through implementation of the present disclosure. The objectives and advantages of the present disclosure will be achieved through the structure specifically pointed out in the description, claims, and the accompanying drawings.

### BRIEF DESCRIPTION OF THE DRAWINGS

In order to illustrate the technical solution in embodiments of the present disclosure more clearly, the drawings required in the description of the embodiments will be introduced below in a brief manner. In the drawings:

FIG. 1 schematically shows domains of liquid crystal molecules in the prior art;

FIG. 2 schematically shows a liquid crystal panel provided by embodiment 1 of the present disclosure;

FIG. 3 schematically shows a liquid crystal panel provided by embodiment 2 of the present disclosure; and

FIG. 4 schematically shows a liquid crystal panel provided by embodiment 3 of the present disclosure.

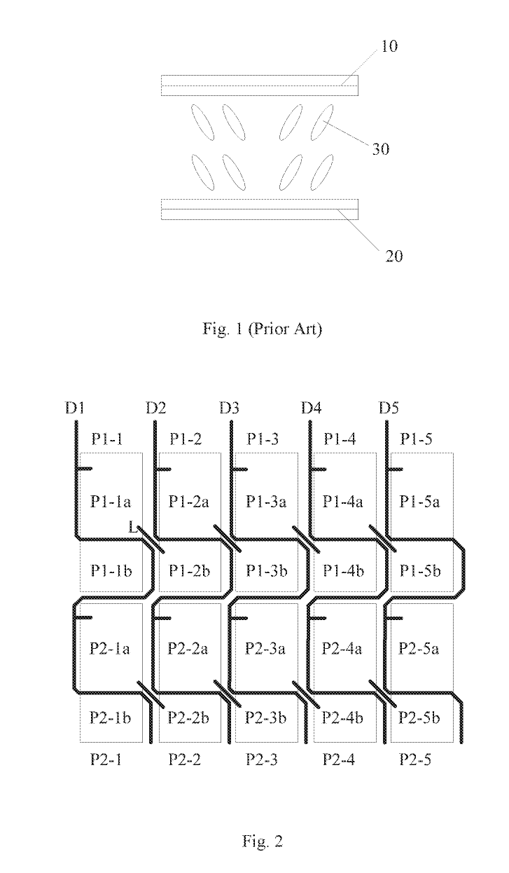

### DETAILED DESCRIPTION OF THE EMBODIMENTS

The implementations of the present disclosure will be described below in detail in combination with the drawings and the embodiments, thereby enabling the realization process concerning how the present disclosure applies technical means to solve technical problems and achieves corresponding technical effects to be fully understood and implemented. It should be noted that, various embodiments in the present disclosure and various features in various embodiments can be combined with one another without any conflict, and each of the technical solutions formed by them falls within the scope of protection of the present disclosure.

An embodiment of the present disclosure provides a liquid crystal panel, which comprises a plurality of sub-pixel units arranged in an array, and each of the sub-pixel units comprises at least two sub-pixels. At least one sub-pixel in one sub-pixel unit has a potential the same as that of at least one sub-pixel in an adjacent sub-pixel unit.

In such case, a plurality of sub-pixels in one sub-pixel unit can have different potentials. Therefore, liquid crystal molecules in different sub-pixels will also have different inclination angles, which improves color washout at a large viewing angle, thus enlarging the viewing angle of a display device.

### Embodiment 1

As shown in FIG. 2, a liquid crystal panel provided by the present embodiment comprises a plurality of sub-pixel units arranged in an array, and each of the sub-pixel units comprises one primary sub-pixel and one secondary sub-pixel. For example, a sub-pixel unit P1-1 in a first row comprises a primary sub-pixel P1-1a and a secondary sub-pixel P1-1b; and a sub-pixel unit P1-2 in the first row comprises a primary sub-pixel P1-2a and a secondary sub-pixel P1-2b. For another example, a sub-pixel unit P2-1 in a second row comprises a primary sub-pixel P2-1a and a secondary sub-pixel P2-1b; and a sub-pixel unit P2-2 in the second row comprises a primary sub-pixel P2-2a and a secondary sub-pixel P2-2b.

In this embodiment, the primary sub-pixel in one sub-pixel unit has a potential the same as that of the secondary sub-pixel in an adjacent sub-pixel unit. Specifically, each sub-pixel is provided with a pixel electrode, and pixel electrodes in the sub-pixels having the same potential are connected to each other. In other words, the pixel electrode of the primary sub-pixel in one sub-pixel unit is connected with the pixel electrode of the secondary sub-pixel in an adjacent sub-pixel unit.

For example, the pixel electrode of the primary sub-pixel P1-1a in the sub-pixel unit P1-1 is connected with the pixel electrode of the secondary sub-pixel P1-2b in the sub-pixel unit P1-2. For another example, the pixel electrode of the primary sub-pixel P1-2a in the sub-pixel unit P1-2 is connected with the pixel electrode of a secondary sub-pixel P1-3b in a sub-pixel unit P1-3.

In this embodiment, the pixel electrodes are connected to each other by a metal line. It can be seen from FIG. 2 that, the pixel electrode of the primary sub-pixel P1-1a in the sub-pixel unit P1-1 is connected with the pixel electrode of the secondary sub-pixel P1-2b in the sub-pixel unit P1-2 by a metal line L.

The pixel electrode of the primary sub-pixel in each of the sub-pixel units is connected with a data line by one thin film transistor. For example, the pixel electrode of the primary sub-pixel P1-1a in the sub-pixel unit P1-1 is connected with a data line D1 by one thin film transistor; and the pixel electrode of the primary sub-pixel P2-1a in the sub-pixel unit P2-1 is also connected with the data line D1 by one thin film transistor.

When a data signal in the data line D1 is transmitted to the pixel electrode of the primary sub-pixel P1-1a in the sub-pixel unit P1-1 by the thin film transistor, the data signal is also transmitted to the pixel electrode of the secondary sub-pixel P1-2b in the sub-pixel unit P1-2 by the metal line L, such that the primary sub-pixel P1-1a has a potential the same as that of the secondary sub-pixel P1-2b.

In a similar manner, the primary sub-pixel in each sub-pixel unit has a potential the same as that of the secondary sub-pixel in an adjacent sub-pixel unit. In such case, the primary and secondary sub-pixels located in one sub-pixel unit will have different potentials. Therefore, liquid crystal molecules in the primary and secondary sub-pixels can have different inclination angles, which reduces color washout phenomenon at a large viewing angle, thus enlarging the viewing angle of a display device.

As a preferred embodiment, the metal line L and data lines D1-D5 in the present embodiment are arranged in a same layer, such that the metal line L and the data lines D1-D5 can be formed in one same mask patterning procedure. In such case, there is no need to add additional manufacturing steps for the metal line L.

Further, each of the primary and secondary sub-pixels is divided into at least four domains, and liquid crystal molecules in each of the domains have their own inclination angles. An example in which each of the sub-pixels is divided into four domains is illustrated below. In this example, each of the sub-pixels comprises four kinds of liquid crystal molecules deflecting towards different directions. Furthermore, since each sub-pixel unit comprises two sub-pixels having different potentials, each sub-pixel unit comprises eight kinds of liquid crystal molecules deflecting towards different directions. In such case, color washout can be further alleviated, and the viewing angle of the display device can be further enlarged. Moreover, since each of the sub-pixel units in the embodiment of the present disclosure is only provided with one thin film transistor, the overall aperture ratio of the liquid crystal panel can be improved.

Certainly, each of the sub-pixels can also be divided into eight or more domains so that the display device can have a wider viewing angle.

### Embodiment 2

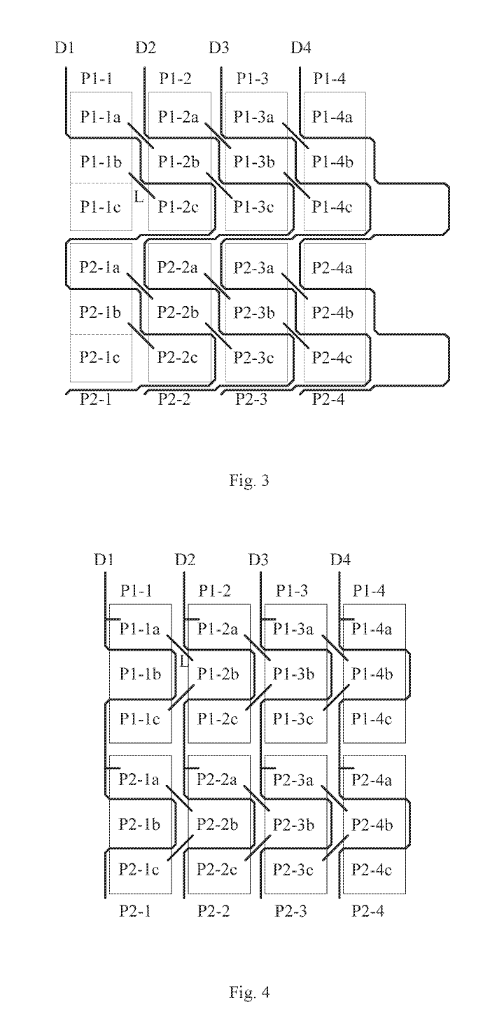

As shown in FIG. 3, the liquid crystal panel provided by the present embodiment comprises a plurality of sub-pixel units arranged in an array, and each of the sub-pixel units comprises a first sub-pixel, a second sub-pixel and a third sub-pixel. For example, a sub-pixel unit P1-1 in a first row comprises a first sub-pixel P1-1a, a second sub-pixel P1-1b and a third sub-pixel P1-1c; and a sub-pixel unit P1-2 in the first row comprises a first sub-pixel P1-2a, a second sub-pixel P1-2b and a third sub-pixel P1-2c. For another example, a sub-pixel unit P2-1 in a second row comprises a first sub-pixel P2-1a, a second sub-pixel P2-1b and a third sub-pixel P2-1c; and a sub-pixel unit P2-2 in the second row comprises a first sub-pixel P2-2a, a second sub-pixel P2-2b and a third sub-pixel P2-2c.

In this embodiment, in three adjacent sub-pixel units, the second sub-pixel in a middle sub-pixel unit has a potential the same as that of the first sub-pixel in a left sub-pixel unit, and the same as that of the third sub-pixel in a right sub-pixel unit. Specifically, each sub-pixel is provided with a pixel electrode, and pixel electrodes in the sub-pixels having the same potential are connected to each other.

For example, the pixel electrode of the second sub-pixel P1-2b in the sub-pixel unit P1-2 is connected with the pixel electrode of the first sub-pixel P1-1a in the sub-pixel unit P1-1, and also with the pixel electrode of a third sub-pixel P1-3c in a sub-pixel unit P1-3. For another example, the pixel electrode of a second sub-pixel P1-3b in the sub-pixel unit P1-3 is connected with the pixel electrode of the first sub-pixel P1-2a in the sub-pixel unit P1-2, and also with the pixel electrode of a third sub-pixel P1-4c in a sub-pixel unit P1-4.

In this embodiment, the pixel electrode of the first sub-pixel in each of the sub-pixel units is connected with a data line by one thin film transistor. For example, the pixel electrode of the first sub-pixel P1-1a in the sub-pixel unit P1-1 is connected with a data line D1 by one thin film transistor; and the pixel electrode of the first sub-pixel P2-1a in the sub-pixel unit P2-1 is also connected with the data line D1 by one thin film transistor. Furthermore, the pixel electrodes are connected to each other by a metal line L, and the metal line L and data lines D1-D4 are arranged in a same layer.

When a data signal in the data line D1 is transmitted to the pixel electrode of the first sub-pixel P1-1a in the sub-pixel unit P1-1 by the thin film transistor, the data signal is also transmitted to the pixel electrode of the second sub-pixel P1-2b in the sub-pixel unit P1-2 by the metal line L, and then transmitted to the pixel electrode of the third sub-pixel P1-3c in the sub-pixel unit P1-3 by the metal line L, such that the sub-pixels P1-1a, P1-2b and P1-3c have a same potential.

In a similar manner, the first, second and third sub-pixels in one sub-pixel unit can have different potentials. Therefore, liquid crystal molecules in the first, second and third sub-pixels will also have different inclination angles, which alleviates color washout phenomenon at a large viewing angle, thus enlarging the viewing angle of a display device. Moreover, since each of the sub-pixel units in the embodiment of the present disclosure is only provided with one thin film transistor, the overall aperture ratio of the liquid crystal panel can be improved.

Further, each of the sub-pixels can be divided into four or more domains, and liquid crystal molecules in each of the domains have their own inclination angles. In such case, color washout can be further alleviated, and the viewing angle of the display device can also be further enlarged.

### Embodiment 3

As shown in FIG. 4, the liquid crystal panel provided by the present embodiment comprises a plurality of sub-pixel units arranged in an array, and each of the sub-pixel units comprises a first sub-pixel, a second sub-pixel and a third sub-pixel. For example, a sub-pixel unit P1-1 in a first row comprises a first sub-pixel P1-1a, a second sub-pixel P1-1b and a third sub-pixel P1-1c; and a sub-pixel unit P1-2 in the first row comprises a first sub-pixel P1-2a, a second sub-pixel P1-2b and a third sub-pixel P1-2c. For another example, a sub-pixel unit P2-1 in a second row comprises a first sub-pixel P2-1a, a second sub-pixel P2-1b and a third sub-pixel P2-1c; and a sub-pixel unit P2-2 in the second row comprises a first sub-pixel P2-2a, a second sub-pixel P2-2b and a third sub-pixel P2-2c.

In this embodiment, the second sub-pixel in one sub-pixel unit has a potential the same as that of the first and third sub-pixels in an adjacent sub-pixel unit. Specifically, each of the sub-pixels is provided with a pixel electrode, and pixel electrodes in the sub-pixels having the same potential are connected to each other.

For example, the pixel electrode of the second sub-pixel P1-2b in the sub-pixel unit P1-2 is connected with the pixel electrodes of the first and third sub-pixels P1-1a and P1-1c in the sub-pixel unit P1-1. For another example, the pixel electrode of a second sub-pixel P1-3b in a sub-pixel unit P1-3 is connected with the pixel electrodes of the first and third sub-pixels P1-2a and P1-2c in the sub-pixel unit P1-2.

In this embodiment, the pixel electrode of the first sub-pixel in each of the sub-pixel units is connected with a data line by one thin film transistor. For example, the pixel electrode of the first sub-pixel P1-1a in the sub-pixel unit P1-1 is connected with a data line D1 by one thin film transistor, and the pixel electrode of the first sub-pixel P2-1a in the sub-pixel unit P2-1 is also connected with the data line D1 by one thin film transistor. Furthermore, the pixel electrodes are connected to each other by a metal line L, and the metal line L and data lines D1-D4 are arranged in a same layer.

When a data signal in the data line D1 is transmitted to the pixel electrode of the first sub-pixel P1-1a in the sub-pixel unit P1-1 by the thin film transistor, the data signal is also transmitted to the pixel electrode of the second sub-pixel P1-2b in the sub-pixel unit P1-2 by the metal line L, and then transmitted to the pixel electrode of the third sub-pixel P1-1c in the sub-pixel unit P1-1 by the metal line L, such that the sub-pixels P1-1a, P1-2b and P1-1c have the same potential.

In a similar manner, the potential of the first and third sub-pixels in one sub-pixel unit is different from that of the second sub-pixel. Therefore, the inclination angles of liquid crystal molecules in the first and third sub-pixels are also different from the inclination angle of liquid crystal molecules in the second sub-pixel, which alleviates color washout phenomenon at a large viewing angle, thus enlarging the viewing angle of a display device. Moreover, since each of the sub-pixel units in the embodiment of the present disclosure is only provided with one thin film transistor, the overall aperture ratio of the liquid crystal panel can be improved.

Further, each of the sub-pixels can be divided into four or more domains, and liquid crystal molecules in each of the domains have their own inclination angles. In such case, color washout can be further alleviated, and the viewing angle of the display device can also be further enlarged.

It should be noted that, the area proportion of each of the sub-pixels in each of the sub-pixel units can be set properly according to various factors such as the resolution ratio of the liquid crystal panel and minimization of color washout.

### Embodiment 4

The present embodiment provides a display device. The display device comprises a liquid crystal panel provided by any one of the above embodiments, a backlight module and other components. As a preferred embodiment, the display device provided by the embodiment of the present disclosure is a vertical alignment liquid crystal display device.

As the display device provided by the embodiment of the present disclosure has the same technical features as the liquid crystal panels provided by the above embodiments, it can similarly solve the same technical problem, and obtain the same technical effects.

Although the implementations are disclosed by the present disclosure as above, the described contents are implementations adopted for the purpose of facilitating an understanding of the present disclosure only, and not for the purpose of limiting the present disclosure. For those skilled in the art to which the present disclosure pertains, all of them can make any modifications and changes to the forms and details of implementation without departing from the spirit and scope disclosed by the present disclosure, but the scope of patent protection of the present disclosure shall still be subject to the scope defined by the appended claims.

1. A liquid crystal panel, comprising a plurality of sub-pixel units arranged in an array, wherein each of the sub-pixel units comprises at least two sub-pixels; and
wherein at least one sub-pixel in one sub-pixel unit has a potential the same as that of at least one sub-pixel in an adjacent sub-pixel unit.

2. The liquid crystal panel of claim 1, wherein each of the sub-pixels is provided with a pixel electrode; and
wherein the pixel electrode of at least one sub-pixel in one sub-pixel unit is connected with the pixel electrode of at least one sub-pixel in an adjacent sub-pixel unit.

3. The liquid crystal panel of claim 2, wherein the pixel electrodes are connected to each other by a metal line.

4. The liquid crystal panel of claim 3, wherein the metal line is arranged in a same layer as data lines.

5. The liquid crystal panel of claim 1, wherein each sub-pixel is divided into at least four domains, and liquid crystal molecules in each of the domains have their own inclination angles.

6. The liquid crystal panel of claim 1, wherein each sub-pixel unit comprises one primary sub-pixel and one secondary sub-pixel; and
wherein the primary sub-pixel in one sub-pixel unit has a potential the same as that of the secondary sub-pixel in an adjacent sub-pixel unit.

7. The liquid crystal panel of claim 1, wherein each sub-pixel unit comprises a first sub-pixel, a second sub-pixel and a third sub-pixel; and
wherein in three adjacent sub-pixel units, the second sub-pixel in a middle sub-pixel unit has a potential the same as that of the first sub-pixel in a left sub-pixel unit, and the same as that of the third sub-pixel in a right sub-pixel unit.

8. The liquid crystal panel of claim 1, wherein each sub-pixel unit comprises a first sub-pixel, a second sub-pixel and a third sub-pixel; and
wherein the second sub-pixel in one sub-pixel unit has a potential the same as that of the first sub-pixel and the third sub-pixel in an adjacent sub-pixel unit.

9. A display device, wherein the display device comprises a liquid crystal panel, which comprises a plurality of sub-pixel units arranged in an array, wherein each of the sub-pixel units comprises at least two sub-pixels, and at least one sub-pixel in one sub-pixel unit has a potential the same as that of at least one sub-pixel in an adjacent sub-pixel unit.

10. The display device of claim 9, wherein each of the sub-pixels of the liquid crystal panel is provided with a pixel electrode; and
wherein the pixel electrode of at least one sub-pixel in one sub-pixel unit is connected with the pixel electrode of at least one sub-pixel in an adjacent sub-pixel unit.

11. The display device of claim 10, wherein the pixel electrodes of the liquid crystal panel are connected to each other by a metal line.

12. The display device of claim 11, wherein the metal line of the liquid crystal panel is arranged in a same layer as data lines.

13. The display device of claim 12, wherein each sub-pixel of the liquid crystal panel is divided into at least four domains, and liquid crystal molecules in each of the domains have their own inclination angles.

14. The display device of claim 9, wherein the display device is a vertical alignment liquid crystal display device.
